(19) United States
(12) Patent Application Publication
(10) Pub. No.: US 2008/0014311 A1
(43) Pub. Date: Jan. 17, 2008

(54) Pet treat and process for making same

(76) Inventors: Jacob Tepper, Boca Raton, FL (US); Steven Mendal, New York, NY (US)

Correspondence Address: MCCARTER & ENGLISH, LLP, FOUR GATEWAY CENTER, 100 MULBERRY STREET, NEWARK, NJ, 07102, US

(21) Appl. No.: 11/825,990

(22) Filed: Jul. 10, 2007

Related U.S. Application Data
(60) Provisional application No. 60/819,844, filed on Jul. 11, 2006.

(51) Int. Cl. A23P 1/08; A21D 2/00; A23B 4/14; A23L 1/31; A23L 1/315; A23L 3/26

(52) U.S. Cl. 426/92; 426/237; 426/332; 426/622; 426/641

(57) ABSTRACT

A pet treat includes an outer layer of meat and an inner layer of rawhide that is surrounded by the outer layer of meat. During a dehydration step that is performed for more than twenty-four hours, the rawhide is flavored by liquid seeped from the meat.

### CROSS-REFERENCE TO RELATED APPLICATION

This application claims the benefit of U.S. Provisional Patent Application No. 60/819,844 filed Jul. 11, 2006, the disclosure of which is incorporated herein by reference in its entirety.

### FIELD OF THE INVENTION

The present invention relates to pet treats and to a process for making same.

### BACKGROUND OF THE INVENTION

It is well known that chewing provides numerous health benefits to pets. For example, chewing allows pets to exercise their jaws. Chewing also promotes teeth cleaning, thereby reducing plaque and tartar buildup.

In an effort to realize the foregoing benefits, pet treats have been developed to promote chewing over an extended period of time. These pet treats are commonly made with pure rawhide. However, such rawhide pet treats are typically dry and lack substantial flavor, and are therefore unappealing to pets.

Some rawhide pet treats are coated with flavorings in an attempt to improve their palatability. Because the coatings are only applied to the outer layer of such rawhide pet treats, the remaining (i.e., uncoated) portions of these treats still lack substantial flavor. As a result, pets rapidly consume the coated outer layer, and then do not chew on the remaining portions of the treat. Accordingly, pets tend to chew on rawhide pet treats for only a relatively short period of time.

Another type of pet treat is made with pure meat. While these pet treats may be palatable, they are rapidly consumed and therefore do not promote chewing for an extended period of time.

### SUMMARY OF THE INVENTION

The present invention overcomes the disadvantages and shortcomings of the prior art discussed above by providing a new and improved pet treat. More particularly, the pet treat includes an outer layer of meat, which is highly palatable. The pet treat also includes an inner layer of rawhide that has been flavored with meat, thereby improving the palatability of the rawhide. The inner layer of flavored rawhide is surrounded by the outer layer of meat. Thus, the pet treat provides two separate treats.

A new and improved process for preparing the pet treat is also provided. Meat is mixed with additives to form a meat/additive mixture, which is mixed with rice flour thereby forming a meat/additive/rice flour mixture. Rawhide is added to the meat/additive/rice flour mixture such that the rawhide is substantially encapsulated within the meat/additive/rice flour mixture. The meat/additive/rice flour/rawhide mixture is roasted for more than twenty-four hours. During this dehydration step, the rawhide is flavored by liquid seeped from the meat.

### BRIEF DESCRIPTION OF THE DRAWINGS

For a more complete understanding of the present invention, reference is made to the following detailed description of an exemplary embodiment of the present invention considered in conjunction with the accompanying drawings, in which:

FIG. 1 is a perspective view of a pet treat which has been prepared in accordance with one exemplary embodiment of the present invention;

FIG. 2 is a cross-sectional view, taken along section line 2-2 and looking in the direction of the arrows, of the pet treat shown in FIG. 1; and

FIG. 3 is a cross-sectional view, taken along section line 3-3 and looking in the direction of the arrows, of the pet treat shown in FIG. 1.

### DETAILED DESCRIPTION OF THE INVENTION

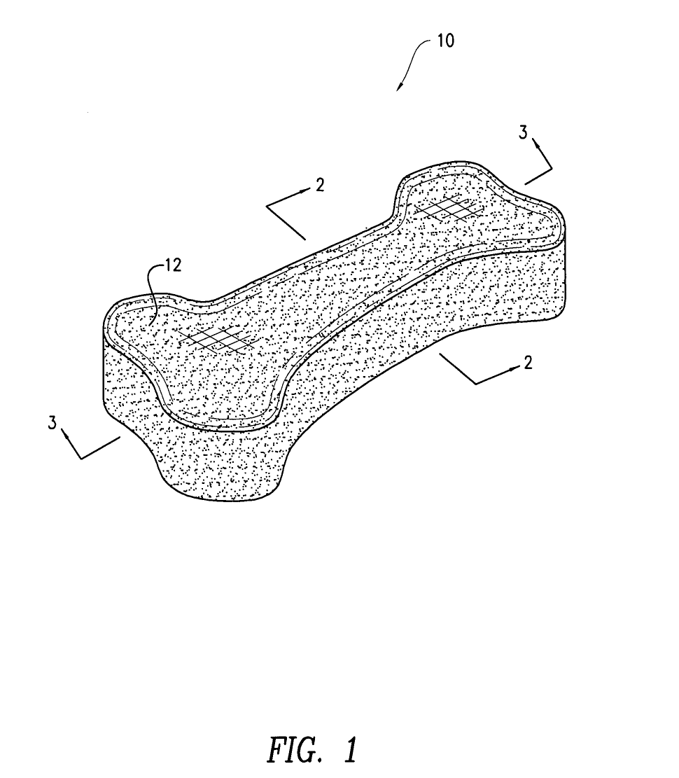

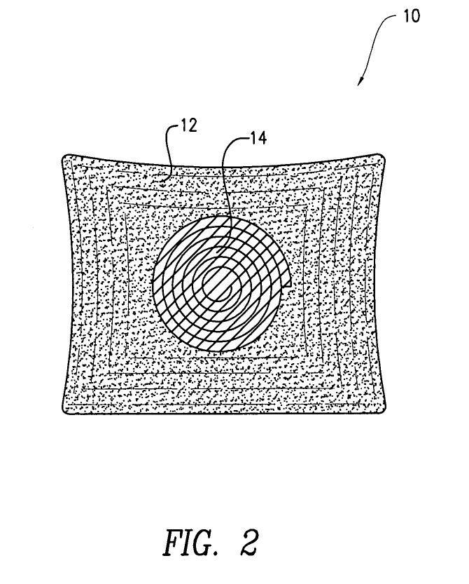

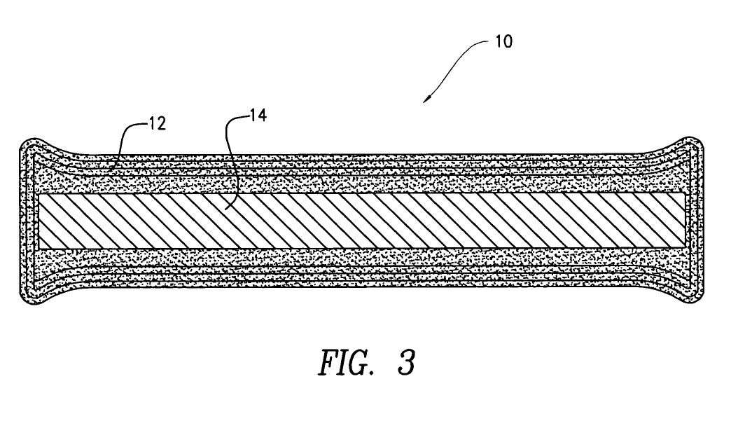

FIGS. 1-3 illustrate a pet treat 10 including an outer layer 12 (see FIGS. 1-3) made of meat and an inner layer 14 (see FIGS. 2 and 3) made of rawhide that has been flavored with meat during the manufacturing process. As used hereinafter, the term “meat” could include, but is not limited to, chicken, beef, pork, lamb, turkey, fish, any other animal meat, or a combination of animal meats.

The pet treat 10 has a bone-shape, but it is understood that the pet treat 10 can have other shapes, such as a heart-shape, cubic, a rectangular prism, polyhedron, etc. Likewise, the inner layer 14 (see FIGS. 2 and 3) of flavored rawhide has a cylindrical shape, but it is understood that the inner layer 14 can have other shapes, such as a prism, polyhedron, polygon, etc. The inner layer 14 of flavored rawhide is rolled in order to form the cylindrical shape, but it is understood that the inner layer 14 does not have to be rolled.

The inner layer 14 of flavored rawhide has a length that is smaller than the length of the outer layer 12 of meat, and the inner layer 14 of flavored rawhide has a width that is also smaller than the width of the outer layer 12 of meat. Further, the inner layer 14 of flavored rawhide has a height that is smaller than the height of the outer layer 12 of meat. As a result, the inner layer 14 of flavored rawhide is substantially encapsulated within the outer layer 12 of meat such that the inner layer 14 of flavored rawhide is enveloped by and concealed within the outer layer 12 of meat.

The process for preparing the pet treat 10 involves a first step of allowing frozen meat to thaw naturally. The thawed meat is then cleaned out thoroughly by performing two separate steps. More particularly, the first cleaning step involves washing the meat with a disinfecting agent, such as 50 ppm potassium hypochlorite water, in order to reduce the microbial content of the meat. The second cleaning step involves washing the meat with pure water.

The next step involves mixing the meat with the following additives: 1% to 1.2% of sugar, 0.6% to 1% of salt, 0.1% to 0.15% of potassium sorbate, and 0.04% to 0.1% of araboascorbic acid. It will be understood that all of these percentages are provided on a weight basis.

Sugar and salt are added to improve the palatability of the meat. Potassium sorbate and araboascorbic acid serve as antiseptic agents. Araboascorbic acid also functions to brighten the color of the meat.

After the meat is mixed with the additives, the meat/additive mixture is ground or wrung into a paste. Any conventional grinder may be used for this grinding step. Such grinders are known to those having ordinary skill in the art and are available from commercial sources.

Rice flour is then added to the mashed meat/additive mixture until the proportion of the meat/additive mixture to the rice flour is approximately 5 to 1. It is understood that other proportions of the meat/additive mixture to the rice flour can be used, provided that enough rice flour is added so that the pet treat 10 can maintain a desired shape that pure meat could not achieve. Rice flour also functions to brighten the color of the meat/additive mixture.

The meat/additive mixture and rice flour are then ground or wrung until the meat/additive mixture is evenly mixed with the rice flour to form a meat/additive/rice flour mixture. Any conventional grinder may be used for this grinding step as well. Such grinders are known to those having ordinary skill in the art and are readily available from commercial sources.

The meat/additive/rice flour mixture is then placed into a mold. More particularly, approximately half of the meat/additive/rice flour mixture is initially placed into the mold so as to form a flat layer of the mixture on a bottom portion of the mold. Rawhide is then placed on the meat/additive/rice flour mixture that is situated in the mold. The remaining portion of the meat/additive/rice flour mixture is then added to the mold. In this manner, the two portions of the meat/additive/rice flour mixture cooperate to substantially encapsulate or envelop the rawhide. The mold is then compressed in a conventional manner to form a molded product which includes a combination of the meat/additive/rice flour mixture and rawhide. The rawhide provides a surface for pets to grind their teeth against and also functions as a support to maintain the shape of the resulting pet treat 10.

The shape of the mold can be selected so as to approximate the desired configuration of the resulting pet treat 10. Any conventional molding machine may be used. Such molding machines are known to those having ordinary skill in the art and are available from commercial sources.

After the molding step, the molded product is placed onto a conventional stainless steel shelf and roasted in a conventional drying house for more than 24 hours at a temperature of from about 65 degrees Celsius to about 85 degrees Celsius until its moisture content is reduced to less than 14%. During the drying step, the rawhide is flavored by liquid seeped from the meat, thereby enhancing the palatability and scent of the rawhide, as well as reducing the hardness of the rawhide, which makes the rawhide more chewable and appealing. Because the molded product is roasted for more than 24 hours, the rawhide is flavored with liquid seeped from the meat for a long period of time.

The dried molded product is then sterilized with ozone for approximately two hours. Lastly, the dried molded product is irradiated at a minimum dose of 7 kGy.

The pet treat 10 (see FIGS. 1-3) that results from the foregoing process contains an inner layer 14 (see FIGS. 2 and 3) of flavored rawhide surrounded by an outer layer 12 (see FIGS. 1-3) of meat. The ratio of meat to rawhide can vary. In one embodiment, the ratio of meat to rawhide is approximately 60 to 40 by weight and/or by volume.

It should be appreciated that the pet treat 10 provides numerous advantages over the prior art pet treats described above. Because the outer layer 12 of the pet treat 10 includes meat, which is highly palatable, soft, and chewable, the pet treat 10 is initially attractive to pets. As the pet chews on the outer layer 12 of meat and consumes the outer layer 12 of meat, the pet will grind and scrape its teeth against the inner layer 14 of flavored rawhide. Such grinding and scraping clean the teeth of the pet, thereby reducing plaque and tartar buildup, as well as providing jaw exercise for the pet.

The improved flavor, scent, and softness of the rawhide encourage the pet to chew on the inner layer 14 of the pet treat 10 after the outer layer 12 of meat is consumed. As a result, the pet will continue to grind and scrape its teeth against the inner layer 14 of flavored rawhide.

As is evident from the description above, the pet treat 10 produced from the foregoing process is chewed for an extended period of time relative to pet treats that include only meat or rawhide. The highly palatable meat and the improved flavor of the rawhide cause the pet to maintain interest in the pet treat 10 until it is substantially or totally consumed.

It should be noted that the present invention can have numerous modifications and variations. For instance, the rawhide can be replaced by any animal skin, such as pork skin. The rawhide can be natural or reformed. The inner layer 14 of the pet treat 10 can include other animal body parts, such as tracheas, tendons, pig ears, tails, hoofs, and bones, which could be knotted or compressed. The rawhide can be twisted, knotted, or rolled. The rice flour can be replaced by other starch sources. The pet treat 10 can be prepared such that a portion of the inner layer 14 of flavored rawhide is visible along an outer edge of the pet treat 10. All such variations and modifications, including those discussed above, are intended to be included within the scope of the invention as defined by the appended claims.

What is claimed is:

1. A method for making a pet treat, which includes meat and rawhide, comprising the steps of:
mixing meat with additives so as to form a meat/additive mixture;
mixing the meat/additive mixture with rice flour so as to form a meat/additive/rice flour mixture;
adding rawhide to the meat/additive/rice flour mixture such that the rawhide is substantially encapsulated within the meat/additive/rice flour mixture; and
roasting the meat/additive/rice flour/rawhide mixture for more than twenty-four hours.

2. The method of claim 1, wherein the step of adding rawhide to the meat/additive/rice flour mixture comprises placing the meat/additive/rice flour mixture into a mold and placing the rawhide into the mold.

3. The method of claim 2, wherein the step of adding rawhide to the meat/additive/rice flour mixture comprising placing approximately half of the meat/additive/rice flour mixture on a bottom portion of the mold, placing the rawhide on the meat/additive/rice flour mixture situated on the bottom portion of the mold, and placing the remaining portion of the meat/additive/rice flour mixture into the mold.

4. The method of claim 3, wherein the step of mixing meat with additives comprises mixing meat with sugar, salt, potassium sorbate, and araboascorbic acid.

5. The method of claim 4, wherein the step of mixing meat with additives comprises mixing meat with 1% to 1.2% of sugar, 0.6% to 1% of salt, 0.1% to 0.15% of potassium sorbate, and 0.04% to 0.1% of araboascorbic acid.

6. The method of claim 5, further comprising the steps of washing the meat with a disinfecting agent and washing the meat with water.

7. The method of claim 6, wherein the step of mixing the meat/additive mixture with rice flour comprises mixing the meat/additive mixture with rice flour until the proportion of the meat/additive mixture to the rice flour is approximately five to one.

8. The method of claim 7, wherein the meat/additive/rice flour/rawhide mixture is roasted for more than twenty-four hours at a temperature of from about 65 degrees Celsius to about 85 degrees Celsius until the moisture content of the meat/additive/rice flour/rawhide mixture is reduced to less than 14%.

9. The method of claim 8, further comprising the steps of sterilizing the meat/additive/rice flour/rawhide mixture with ozone and irradiating the meat/additive/rice flour/rawhide mixture.

10. A method for making a pet treat, which includes meat and rawhide, comprising the steps of:
mixing meat with additives so as to form a meat/additive mixture;
placing a portion of the meat/additive mixture on a mold so as to form a flat layer of the meat/additive mixture;
placing the rawhide on the flat layer of the meat/additive mixture situated on the mold;
placing the remaining portion of the meat/additive mixture into the mold such that the rawhide is substantially encapsulated within the meat/additive mixture; and
roasting the molded meat/additive/rawhide mixture for more than twenty-four hours.

11. The method of claim 10, wherein the step of mixing meat with additives comprises mixing meat with sugar, salt, potassium sorbate, and araboascorbic acid.

12. The method of claim 11, wherein the step of mixing meat with additives comprises mixing meat with 1% to 1.2% of sugar, 0.6% to 1% of salt, 0.1% to 0.15% of potassium sorbate, and 0.04% to 0.1% of araboascorbic acid.

13. The method of claim 10, wherein the meat/additive/rawhide mixture is roasted for more than twenty-four hours at a temperature of from about 65 degrees Celsius to about 85 degrees Celsius until the moisture content of the meat/additive/rawhide mixture is reduced to less than 14%.

14. The method of claim 13, further comprising the step of mixing the meat/additive mixture with rice flour so as to form a meat/additive/rice flour mixture.

15. The method of claim 14, wherein the step of mixing the meat/additive mixture with rice flour comprises mixing the meat/additive mixture with rice flour until the proportion of the meat/additive mixture to the rice flour is approximately five to one.

16. A pet treat, including an outer layer of meat and an inner layer of flavored rawhide, wherein the pet treat is made in accordance with a method comprising the following steps:
mixing meat with additives so as to form a meat/additive mixture;
adding rawhide to the meat/additive mixture such that the rawhide is substantially encapsulated within the meat/additive mixture; and
roasting the meat/additive/rawhide mixture for more than twenty-four hours.

17. The pet treat of claim 16, wherein the step of adding rawhide to the meat/additive mixture comprises placing approximately half of the meat/additive mixture on a bottom portion of the mold, placing the rawhide on the meat/additive mixture situated on the bottom portion of the mold, and placing the remaining portion of the meat/additive mixture into the mold.

18. The pet treat of claim 16, wherein the meat comprises chicken.

19. The pet treat of claim 16, wherein the ratio of meat to rawhide is approximately 60 to 40 by weight.

20. The pet treat of claim 16, further comprising the step of mixing the meat/additive mixture with rice flour so as to form a meat/additive/rice flour mixture.
